(19) United States
(12) Patent Application Publication
(10) Pub. No.: US 2024/0392908 A1
(43) Pub. Date: Nov. 28, 2024

(54) Self Restraining Electrofusion Fitting

(71) Applicant: Georg Fischer Central Plastics LLC, Shawnee, OK (US)

(72) Inventors: Michael D. SMITH, Shawnee, OK (US); Steven W. VANANTWERP, Shawnee, OK (US)

(21) Appl. No.: 18/321,236

(22) Filed: May 22, 2023

(51) Int. Cl. F16L 47/02; B29C 65/00; B29C 65/30

(52) U.S. Cl. CPC F16L 47/02; B29C 65/30; B29C 66/5221

(57) ABSTRACT

An electrofusion coupler has a rigid housing with an internal bore. A coil lines an inner surface of the bore. An annular, unidirectional restraining member is configured to allow one end of a pipe to push through the restraining member in one direction into the internal bore and restrain the pipe from moving in an opposite direction when power is applied to the coil to weld the pipe.

### BACKGROUND OF THE INVENTION

### Technical Field

The present disclosure relates to couplers for pipes and, more particular, to electrofusion couplers.

This section provides background information related to the present disclosure which is not necessarily prior art.

### Discussion

Electrofusion is a process that is often used to weld two plastic pipes together. During the welding process, the ends of the pipes are brought close together and a coil surrounding the pipe provides sufficient heat to weld the pipes together. Unfortunately, during the welding process, the pipe ends sometimes move apart and, thus, cause an inadequate weld. To cure this problem, clamps are often used to hold the pipes together during the electrofusion process. Once the pipes are welded together, the clamps are removed. The configuration of the clamps, of course, need to be compatible with the size of the pipes that are being welded. This means that a number of different clamp configurations must be provided to accommodate different size pipes. This necessity increases costs and is cumbersome to use in the field where the pipes are often buried deep in trenches.

### SUMMARY

This section provides a general summary of the disclosure, and is not a comprehensive disclosure of its full scope or all of its features.

In accordance with the teachings of the present invention, an electrofusion coupler has a rigid housing with an internal bore. A coil lines an inner surface of the bore. An annular, unidirectional restraining member is configured to allow one end of a pipe to push through the restraining member in one direction into the internal bore and restrain the pipe from moving in an opposite direction when power is applied to the coil to weld the pipe.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is an exploded side view of an electrofusion coupler made in accordance with the teachings of this invention;

FIG. 2 is an exploded perspective view of the electrofusion coupler;

FIG. 3 is a cross-sectional view of the assembled electrofusion coupler;

FIG. 4 is a partial enlarged view of FIG. 3 illustrating the pipe ends abutting a stop member;

FIG. 5 is an exploded perspective view of the electrofusion coupler;

FIG. 6 is a perspective view of a subassembly showing a riser attached to one end of the electrofusion coupler housing;

FIG. 7 is similar to FIG. 6 but shows a service tee attached to one end of the electrofusion coupler housing;

FIG. 8 is similar to FIG. 3 but shows an alternate sealing arrangement; and

FIG. 9 is similar to FIG. 8. but shows still another alternative sealing arrangement.

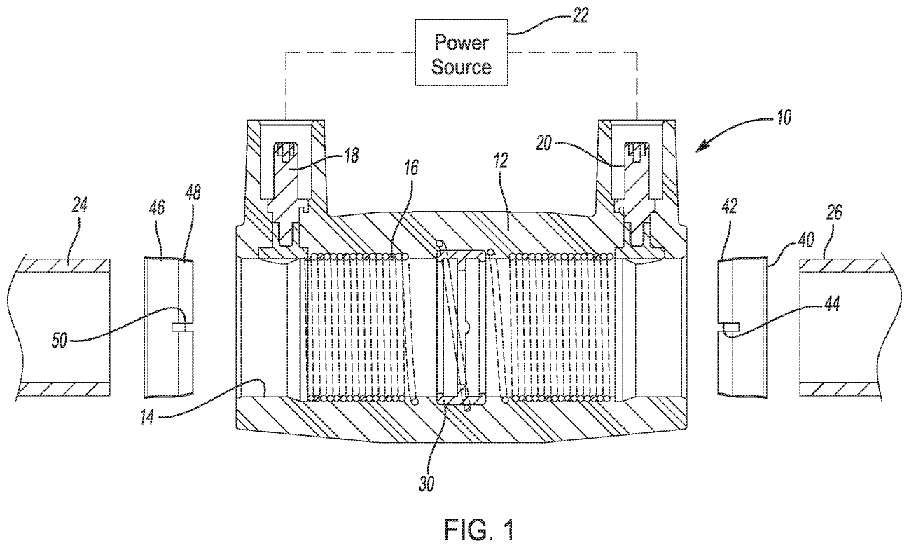

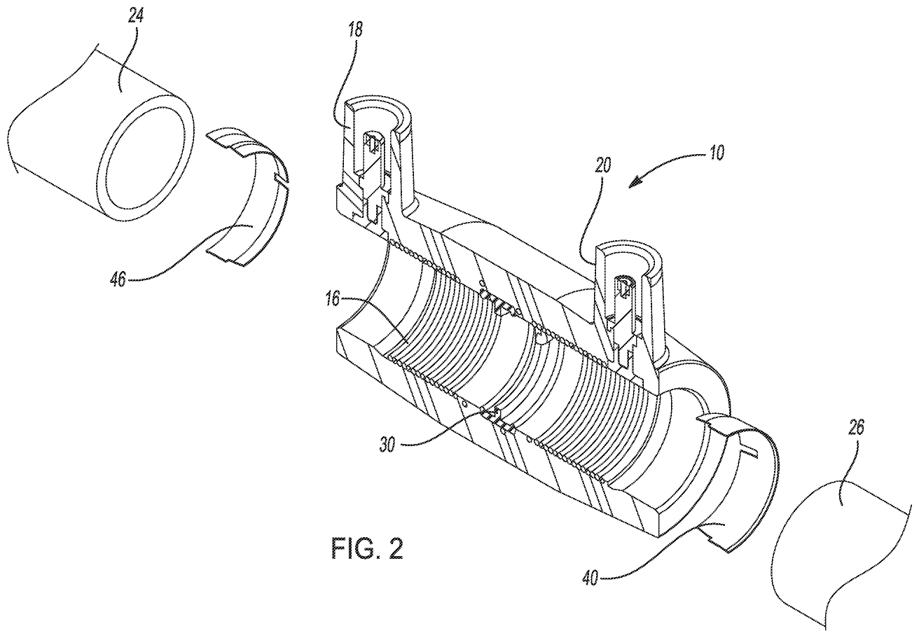

### DETAILED OF THE PREFERRED EMBODIMENTS OF THE INVENTION

Example embodiments will now be described more fully with reference to the accompanying drawings.

Referring now to the drawings, the electrofusion coupler 10 includes a nonconductive tubular housing 12 with an internal bore 14. Electrofusion coil 16 lines the inner wall of the housing bore 14. Ends of the coil 16 are coupled, respectively, to electrodes 18 and 20 which are, in turn, coupled to a power source 22

As will be explained in more detail later on, the electrofusion coupler 10 is used to weld together ends of two opposing plastic pipes 24 and 26.

As best illustrated in FIG. 4, an annular seal 30 is disposed in the central part of housing 12. Seal 30 includes a pair of opposing upright walls 32, 34 that are separated by a web 36. Web 36 includes a radially inwardly extending lip that serves as a stop 38 for the ends of the pipe. For ease of illustration, the ends of the pipes 24, 26 are shown in FIG. 4 spaced a bit farther apart than in actuality.

An annular, unidirectional restraining member 40 is configured to allow one end of pipe 26 to push through the restraining member 40 in one direction (here, right to left) into the internal bore 14 and restrain the pipe 26 from moving in an opposite direction (here, to the right) when power is applied from power source 22 to the coil 16 to weld the pipe 26 to pipe 24.

The restraining member can take several forms in order to accomplish the above function. Here, restraining member 40 includes a radiantly extended inwardly converging ring 42 that is separated by slots 44. This configuration basically forms barbs that will dig in to the pipe 26 to prevent it from moving to the right as shown in the drawings.

Similarly, an annular unidirectional restraining member 46 is configured to allow one end of pipe 24 to push through the restraining member 46 in one direction (here, left to right) into the internal bore 14 and restrain the pipe 24 from moving in an opposite direction (here, to the left) when power is applied from power source 22 to the coil 16 to weld the pipe 24 to pipe 26.

The restraining member 46 can take several forms in order to accomplish the above function. Here, restraining member 46 includes a radiantly extended inwardly converging ring 48 that is separated by slots 50. This configuration basically forms barbs that will dig in to the pipe 24 to prevent it from moving to the left as shown in the drawings.

The electrofusion welding process will now be described. Pipe 26 is pushed through restraining member 40 into the bore 14 of housing 12 until an end of pipe 26 meets the stop 38 in seal 36. Similarly, pipe 24 is pushed through restraining member 46 until an end of pipe 24 meets and opposite shoulder of the stop 38. Then, power is supplied from power source 22 to the coil 16 to provide sufficient heat to partially melt and fuse the opposite ends of pipes 24 and 26 together. The cooperation of the restraining members 40 and 46 prevent their respective pipes 26 and 24 from moving away from each other to facilitate an acceptable weld. This feature does away with the usual removal brackets to perform this function.

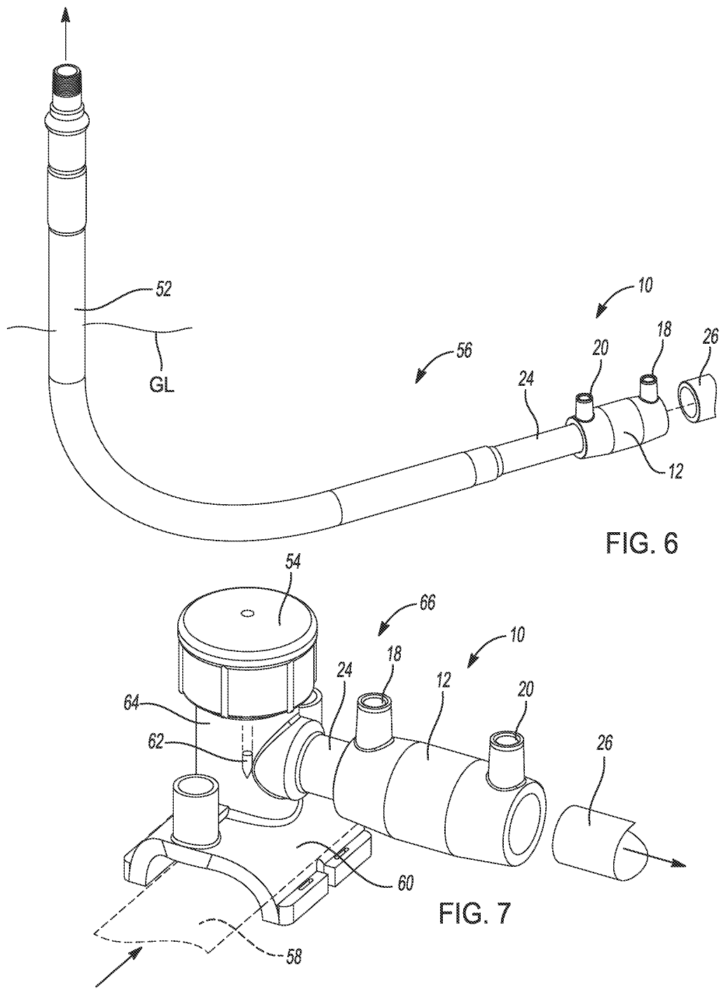

Variants of the present invention are shown in FIGS. 6 and 7. In these figures, auxiliary device is shown preassembled to one end of electrofusion housing 12. The concept is to provide “preassembled subassemblies” with some of the aforementioned parts fitted together so that they can be more easily connected in the field. Quite often, the pipe connection must be made in deep trenches in the field where it is awkward to fit separate parts together. By providing these subassemblies, the connection is made considerably easier.

In FIG. 6, the connector is a riser 52. As is known in the art, a riser 52 sticks out of the ground level GL and, typically, is used to connect to a meter at a building to meter gas flowing through pipe 26 into the building. The manufacturer can pre-assemble the riser 52 into one end of electrofusion housing 12 to form a subassembly 56. This so-called “preassembled subassembly” 56 can be produced in quantities and allows the workman at the site to easily attach natural gas, for example, from pipe 26 to the riser 52 after the pipes 24 and 26 are fused together by the electrofusion coupler 12.

In FIG. 7, the auxiliary device is a service tee. The service tee includes a saddle 60 and a rotating 54 cap. The cap 54 may be removed to provide access for a tool (not shown) which when rotated moves a pointed plunger 62 up and down. Laterally coupled to the mostly hollow main body 64 is a pipe 24 that has been pre-fitted into the electrofusion body 12. Similar to subassembly 56, this subassembly 66 can be pre-assembled in quantities and then transported to the worksite. At the worksite inflow pipe 58 is clamped to and fused to the saddle 60 in a conventional manner using electrofusion coils in the saddle 60. Then, pipe 26 is pressed into the electrofusion body 12 and is fused to pipe 24 in the manner previously described. Then, the cap 54 is removed and the tool is rotated to cause the plunger 62 to move downward and pierce pipe 58. This allows natural gas or the like to flow from pipe 58 upwardly through the body 64 and then laterally through pipe 24 and out of pipe 26.

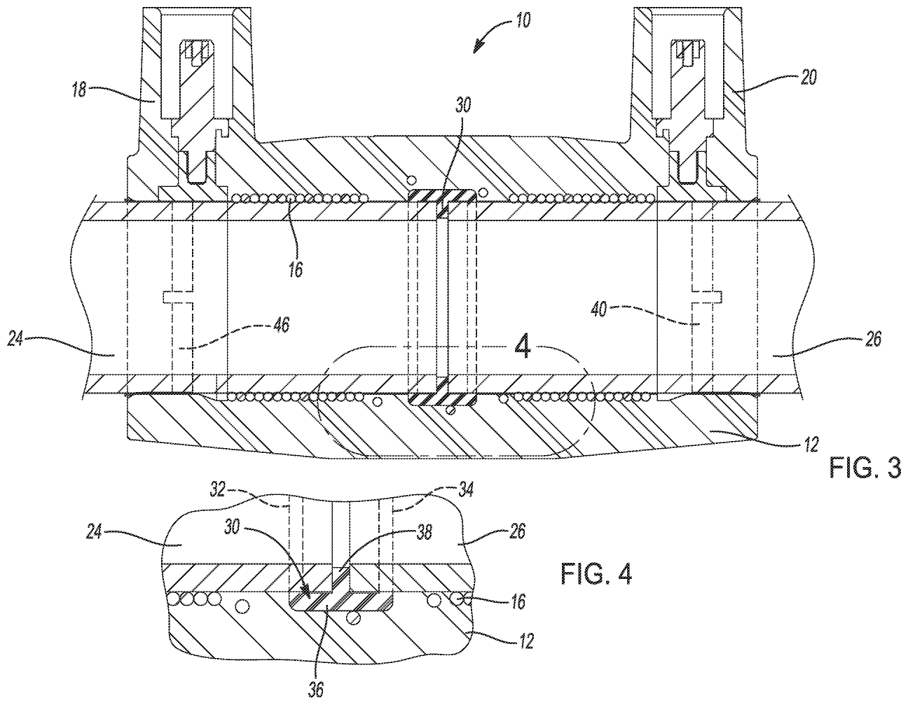

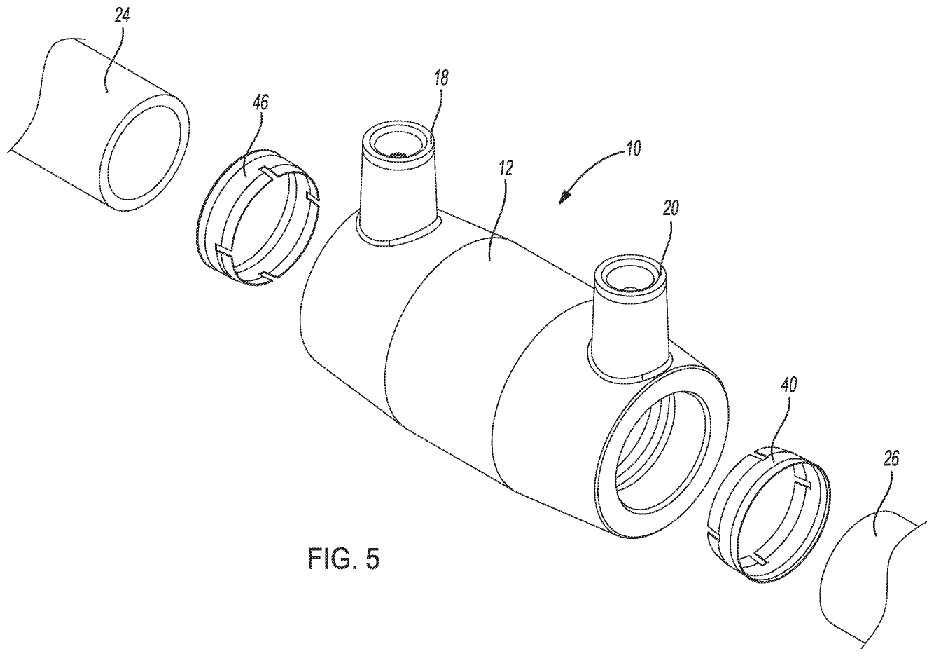

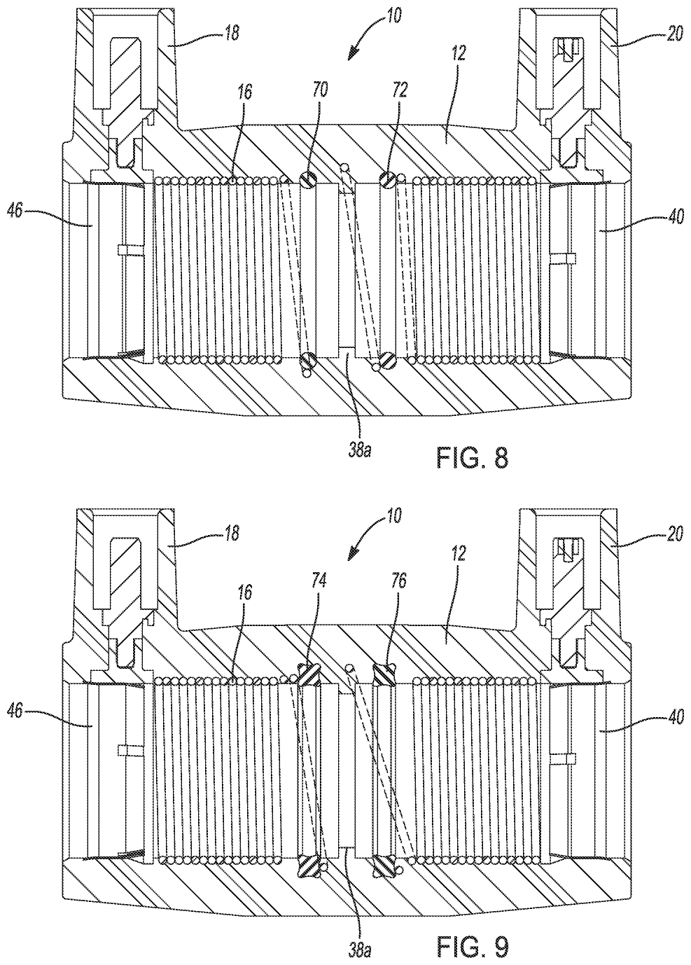

FIG. 8 and FIG. 9 show alternative sealing arrangements to that shown in FIGS. 3 and 4. In FIGS. 8 and 9 a radially inwardly extending stop 38a is integrally formed with the body 12. In FIG. 8 a pair of arcuate seats are formed on opposite sides of stop 38a. In FIG. 9 the seats are essentially square. In FIG. 8 a pair of standard O-rings 70, 72 are located in the seats. In contrast, the seals in FIG. 9 are X rings. These X rings tend to make better contact with the pipes that are inserted into the electrofusion housing 12 to abut stop 38a for fusing together in the manner previously described.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electrofusion coupler for pipes, comprising:
a rigid housing having an internal bore;
a coil lining an inner surface of the bore; and
an annular, unidirectional restraining member configured to allow one end of a pipe to push through the restraining member in one direction into the internal bore and restrain the pipe from moving in an opposite direction when power is applied to the coil to weld the pipe.

2. The electrofusion coupler of claim 1 configured to weld ends of two opposing pipes together, said coupler further comprising:
two restraining members, one for each pipe.

3. The electrofusion coupler of claim 2 which further comprises:
an annular seal centrally located in the bore of the housing, the seal including an inwardly extending lip forming a stop, an end of one of the pipes abutting a shoulder of the stop, with an end of the other pipe abutting an opposing shoulder of the stop.

4. The electrofusion coupler of claim 1 wherein the restraining member further comprises:
a radially inwardly converging ring configured as a barb to engage the pipe.

5. The electrofusion coupler of claim 1 which further comprises:
two electrodes protruding from the housing configured to connect ends of the coil to a power source.

6. The electrofusion coupler of claim 1 which further comprises:
an auxiliary device preassembled to one end of the housing.

7. The electrofusion coupler of claim 6 wherein the auxiliary device comprises a riser configured to couple fluid flowing through the body to an aboveground connection.

8. The electrofusion coupler of claim 6 wherein the auxiliary device comprises a service tee having an outlet coupled to a pipe connected to the body, the service to you further comprises a saddle for receiving a pipe providing incoming fluid, an outlet coupled to the body of the electrofusion coupler, and a puncturing device for piercing the pipe to allow fluid to flow from the pipe to the outlet.

9. The electrofusion coupler of claim 4 wherein the ring further comprises a plurality of longitudinally directed slots.

10. The electrofusion coupler of claim 1 which further comprises a radially inwardly extending stop and a pair of opposing annular seals on opposite sides of the stop.

11. The electrofusion coupler of claim 10 wherein the seals comprise X rings.

12. An electrofusion coupler for pipes, comprising:
a rigid housing having an internal bore, the housing having a centrally located radially extending stop;
a coil lining an inner surface of the bore on opposite sides of the stop;
first and second unidirectional restraining members located at opposite ends of the bore, the first restraining member being configured to allow one end of a pipe to push through the first restraining member in one direction into the internal bore to engage one side of the stop, the second restraining member being configured to allow one end of another pipe to push through the second restraining member in an opposite direction to engage an opposite side of the stop, the first and second restraining members being configured to restrain their respective pipes from moving away from each other when power is applied to the coil to weld the pipes together; and
an annular sealing arrangement extending from an inner surface of the bore of the body and engaging outer surfaces of the pipes adjacent the stop.

13. The electrofusion coupler of claim 12 wherein the sealing arrangement comprises:
an annular seal centrally located in the bore of the housing, the seal including an inwardly extending lip forming a stop, an end of one of the pipes abutting a shoulder of the stop, with an end of the other pipe abutting an opposing shoulder of the stop.

14. The electrofusion coupler of claim 12 wherein the restraining member further comprises:
a radially inwardly converging ring configured as a barb to engage the pipe.

15. The electrofusion coupler of claim 12 which further comprises:
two electrodes protruding from the housing configured to connect ends of the coil to a power source.

16. The electrofusion coupler of claim 12 which further comprises:
an auxiliary device preassembled to one end of the housing.

17. The electrofusion coupler of claim 16 wherein the auxiliary device comprises a riser configured to couple fluid flowing through the body to an aboveground connection.

18. The electrofusion coupler of claim 16 wherein the auxiliary device comprises a service tee having an outlet coupled to a pipe connected to the body, the service to you further comprises a saddle for receiving a pipe providing incoming fluid, an outlet coupled to the body of the electrofusion coupler, and a puncturing device for piercing the pipe to allow fluid to flow from the pipe to the outlet.

19. The electrofusion coupler of claim 14 wherein the ring further comprises a plurality of longitudinally directed slots.

20. The electrofusion coupler of claim 12 wherein the sealing arrangement comprise X rings.
